(19) United States
(12) Patent Application Publication
(10) Pub. No.: US 2008/0073429 A1
(43) Pub. Date: Mar. 27, 2008

(54) Method and system for post purchase monitoring

(76) Inventors: Christopher L. Oesterling, Troy, MI (US); Jeffrey M. Stefan, Clawson, MI (US)

Correspondence Address: JEFFREY M. STEFAN, 909 ELMSFORD DRIVE, CLAWSON, MI, 48017, US

(21) Appl. No.: 11/527,190

(22) Filed: Sep. 26, 2006

(51) Int. Cl. G06K 15/00

(52) U.S. Cl. 235/383

(57) ABSTRACT

A method is provided for post purchase monitoring comprising the steps of receiving purchase information for a purchased item, monitoring for a price change for the purchased item, and notifying a consumer of the price change of the purchased item. The method further comprises registering consumer contact information, and purchase information, wherein the purchase information is comprised of a name of the purchased item, a description of the purchased item, a name of the retail outlet where the item was purchased, a price paid for the purchased item, and a date the item was purchased.

### TECHNICAL FIELD

This invention relates to a method and system for post purchase monitoring.

### BACKGROUND OF THE INVENTION

Retail outlets compete for business by offering price guarantees, return periods, rebates, warranties, and the like. Price guarantees, rebates, warranties inter alia are cumbersome and complicated for a consumer to track. The consumer is first faced with gathering information regarding the duration and conditions of a price guarantee within the return period, then bears the burden of monitoring retail establishments for a favorable price difference.

For example, if a consumer buys an electronic item such as a printer or video recorder, the retail outlet may guarantee the purchase price for thirty days at all of the retail outlets within the same chain of retailers. If the price drops below the consumer's purchase price then the consumer is entitled to the difference between the purchase price and the new lower price within the thirty day period. The consumer is burdened with tracking the current price of the printer or video recorder at multiple retail outlets for the thirty day guarantee period.

Some retail outlets offer a price guarantee for items sold not only at their retail outlets but all retail outlets offering the same item. The diligent consumer is now faced with searching and perusing advertising flyers, Web pages, and making personal visits to various retail outlets to determine whether a favorable price change has occurred for the item bought.

### SUMMARY OF THE INVENTION

A method is provided for post purchase monitoring comprising the steps of receiving purchase information for a purchased item, searching a retail outlet for a price guarantee policy for the purchased item, monitoring for a price change for the purchased item, and notifying a consumer of the price change of the purchased item. The method further comprises registering consumer contact information, purchase information, wherein the purchase information is comprised of a name of the purchased item, a name of the retail outlet where the item was purchased, a price paid for the purchased item, and a date the item was purchased.

### DESCRIPTION OF THE DRAWINGS

Objects, features and advantages of embodiments of the present disclosure may become apparent by reference to the following detailed description and drawings, in which like reference numerals correspond to similar, though not necessarily identical components. For the sake of brevity, reference numerals having a previously described function may not necessarily be described in connection with other drawings in which they appear.

FIG. 1 provides a flow chart for implementing this invention;

FIG. 2a provides a computer display configuration for implementing this invention;

FIG. 2b provides another computer display configuration for implementing this invention;

FIG. 3 provides a schematic diagram of a data structure for implementing this invention;

FIG. 4 provides a schematic diagram of a Web based system for implementing the invention;

FIG. 5 provides a Web page for implementing this invention;

FIG. 6 provides an electronic mail notification for implementing this invention;

FIG. 7 provides another electronic mail notification for implementing this invention; and

FIG. 8 provides a computer display configuration for implementing this invention.

### DESCRIPTION OF EXEMPLARY EMBODIMENTS

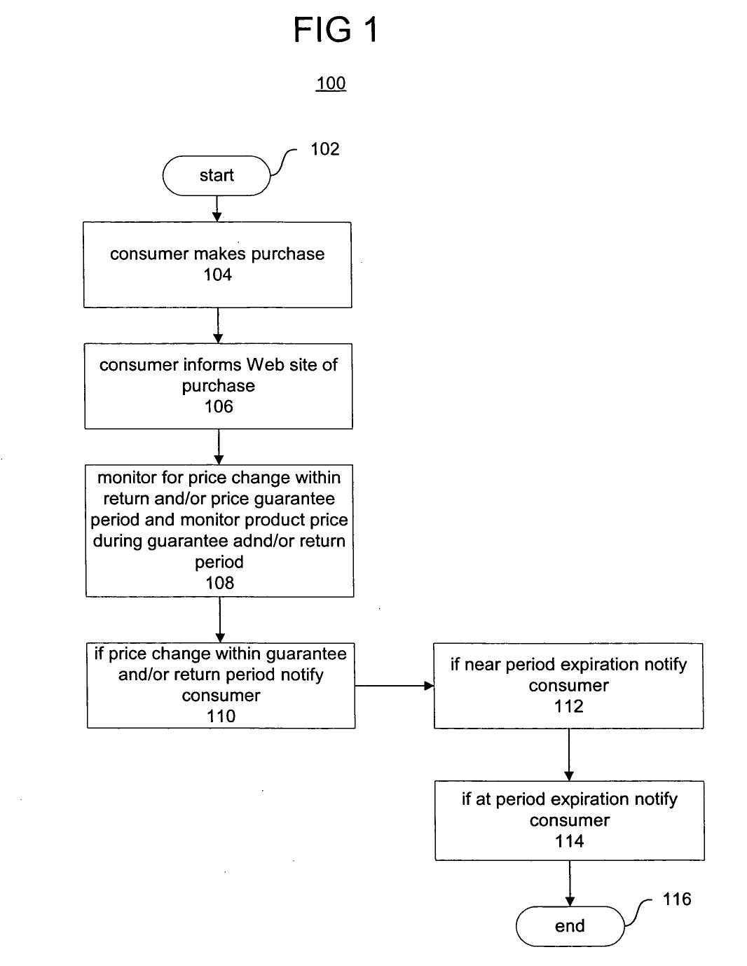

FIG. 1 provides a flow diagram of a method for post purchase monitoring in accordance with one example of the invention as seen at 100. The method begins at 102.

A consumer makes a purchase at a retail outlet as seen at 104. For example, a consumer may buy a video camcorder. The consumer may buy the video camcorder at a brick-and-mortar, physical retail outlet or may order the video camcorder via the retail outlet Web site on the Internet. The retail outlet may offer a price guarantee upon the sale of the camcorder. The price guarantee may, for example, be posted on the retail outlet Web site, may be posted at a physical retail outlet, printed in an advertising flyer, printed on a receipt, and the like. Typically price guarantees are limited to a finite period of time, such as, for example, thirty days. If the consumer finds the same video camcorder for a lesser price at a different retail outlet during the return and/or price guarantee period, then the consumer, upon providing evidence of the lesser price, is entitled to the difference in price. Evidence of the lesser price may be, for example, an advertising flyer depicting the item purchased and the advertised price that is lower than the consumer's purchase price.

The retail outlet may also have a return policy specifying a return period. The return policy, may, for example, be limited to thirty days. Return policies may be limited or unconditional. For example, the retail outlet may charge a restocking fee when an item is returned. In another example, the retail outlet may unconditionally accept any returned item purchased.

The consumer informs a Post Purchase Monitor (PPM), in this example embodied in a Web site, of purchase at step 106. After purchasing an item, the consumer registers the purchase with the PPM. In one example, information provided to the PPM comprises the consumer's contact information such as the consumer's name, email address, home and/or business address, telephone number(s), the name and/or description of the item purchased, the stock number of the item purchased, the date of purchase, the retail outlet where the item was purchased, the price paid, the return period, the price guarantee period, the retail outlet's Universal Resource Locator (URL) and/or combinations thereof. In another example, the consumer may enter only contact information, the product purchased, the date of purchase, the price paid, and the retail outlet where the item was purchased.

In one example, the consumer invokes the PPM via a URL that makes available a Web page. The URL may be, for example, AfterBought.com. The consumer registers with the Web site by filling in contact information. In one example, the PPM may generate an email sent to the consumer where the consumer is required to respond to in order to register with the Web site.

The consumer fills in a form containing fields such as the item purchased, the stock number of the item purchased, the retail outlet where the item was purchased, the retail outlet URL, date of purchase, the price paid for the item, the return period, the price guarantee period, and/or combinations thereof.

The PPM saves the data input in a Consumer Profile Record (CPR). The CPR contains, but is not limited to, consumer contact information, such as the consumer's name, residential address, email addresses, and a password or PIN (Personal Information Number). The CPR contains data records for items purchased, with record fields comprised of the name of the items purchased, item stock numbers, purchase dates, retail outlets where the items were purchased, the location of the retail outlets, the price paid for the items, the price guarantee period, and the return period for the item dictated by the retail outlet's return policy.

It is to be understood that all fields need not be entered by the consumer in the consumer profile record. For example, a consumer may need only enter their name, email address and password to identify themselves to the PPM. The consumer may then enter the item purchased, the price paid, and the date and place of purchase. The PPM, based on the input data, will search the retail outlet's Web site for a return policy and price guarantee policy and will report to the consumer its findings. The report to the consumer may be, in one example, the report may be comprised of an email sent to the consumer's email address. In another example, the report may be a text message to the consumer's cellular phone. In yet another example, the report may be an instant message to one or more of the consumer's personal computers.

As seen in at 108 the PPM monitors for a price change within the return and price guarantee period for the item purchased by the consumer. The PPM may, for example, utilize a Web bot, (also known as a spider, and/or crawler), to search and report on the retail outlet's Web site price for the item purchased within the price guarantee period and/or the return period. A web bot is, for example, a computer program that runs automatically and searches Web pages by accessing hyperlinks. A Web bot, spider, and/or crawler is henceforth referred to as an automaton.

In one example, the PPM initiates an internal timer that, when the timer is running, will periodically utilize the automaton to search and report on the retail outlet's Web site price for the item purchased. The timer is bound by the date the item was purchased, which is the lower bound, and the expiration of the return and/or price guarantee period, which is the upper bound.

The automaton may, for example, enter the product description into the retail outlet's search field. In another example, the automaton may enter in the model number of the purchased item. In yet another example, the automaton may enter the retail outlet's Stock Keeping Unit (SKU) number associated with the purchased item. The automaton will then, for example, initiate the product search by forcing a click event over the search initiation control button, typically marked “go” or “search”. In another example, the automaton may utilize a CGI-BIN input method, known in the art. The information returned, typically a new Web page, may indicate the current price for the product. The automaton may, for example, examine the Hyper Text Markup Language (HTML) encoding which comprises the returned Web page for the current price of the purchased product. In another example, the automaton will examine an advertisement, sometimes in the form of a “weekly ad” hyperlink on the retail outlet's Web page. In parsing the weekly ad, typically written in HTML, the automaton may have access to the most current price for the purchased item if the purchased item is listed in the weekly ad.

Within the timer bounds, another timer may be present to periodically schedule the automaton to visit the Web site. In one example, the scan period may be weekly. In another example, the scan period may be daily. In yet another example, the scan period may be asymmetric, where the scan period may increase in frequency during known sales period, such as during a holiday season.

It is to be understood that a plurality of divergent retail outlets may be visited and reported on by the automaton, that is, different retail chain's Web sites may be visited and reported on for the product purchased. It is also to be understood that a plurality of automatons may be utilized to visit and report on different retail outlet Web sites.

As seen at step 110, the PPM will report the purchase price of the item. In one example, the automaton will parse the HTML in the indexed Web page from the retail outlet's Web site and report the price and retail outlet to the PPM. In another example the automaton will return the indexed Web page to the PPM and the PPM will parse the returned page HTML, extracting the price for the purchased item, if found. It is to be understood that the automaton and the PPM may parse not only HTML but Extended Markup Language (XML) and its derivatives. In another example, a .pdf file containing product information and current pricing, if it exists, may be downloaded from the retailer's Web site and scanned, extracting the price for the purchased item. The consumer receives a price notification of the purchased item via different means, singularly or in combination. For example, the consumer may receive the notification via email sent to one or more email addresses associated with the consumer. In another example the consumer may receive notification as a text message. In yet another example, the consumer may receive notification via an instant message. The consumer may receive notification via an electronic page and/or a telephone call. It is to be understood that a consumer may receive notification in a variety of textural, graphical, and/or audible forms, known in the art.

As seen at step 112, if the timer expiration period is approaching, the consumer is notified via the same means as in step 108. A threshold value before the timer expires may be utilized. For example, if the timer is set to expire in one week, then the consumer is notified that one week remains to receive the difference between the purchase price for the purchased item and the newly offered price, if the newly offered price is favorable to the consumer. In another example, the consumer is notified that the return period for the purchased item will expire in one week. In another example, as the timer expiration period is approached, the PPM may notify the consumer with increased frequency. For example, if three days remain before the timer expires, the consumer may be reminded of the pending expiration daily. In yet another example, no timer is utilized. A system date and time may be accessed by the PPM from the computer the PPM is hosted on. From this the expiration date may be determined. The current date is compared to the price guarantee and/or return expiration date, yielding the time remaining to within the price guarantee and/or return expiration date.

As seen in step 114, if the return period and/or price guarantee period expires, then the consumer is notified. The method steps end at 116.

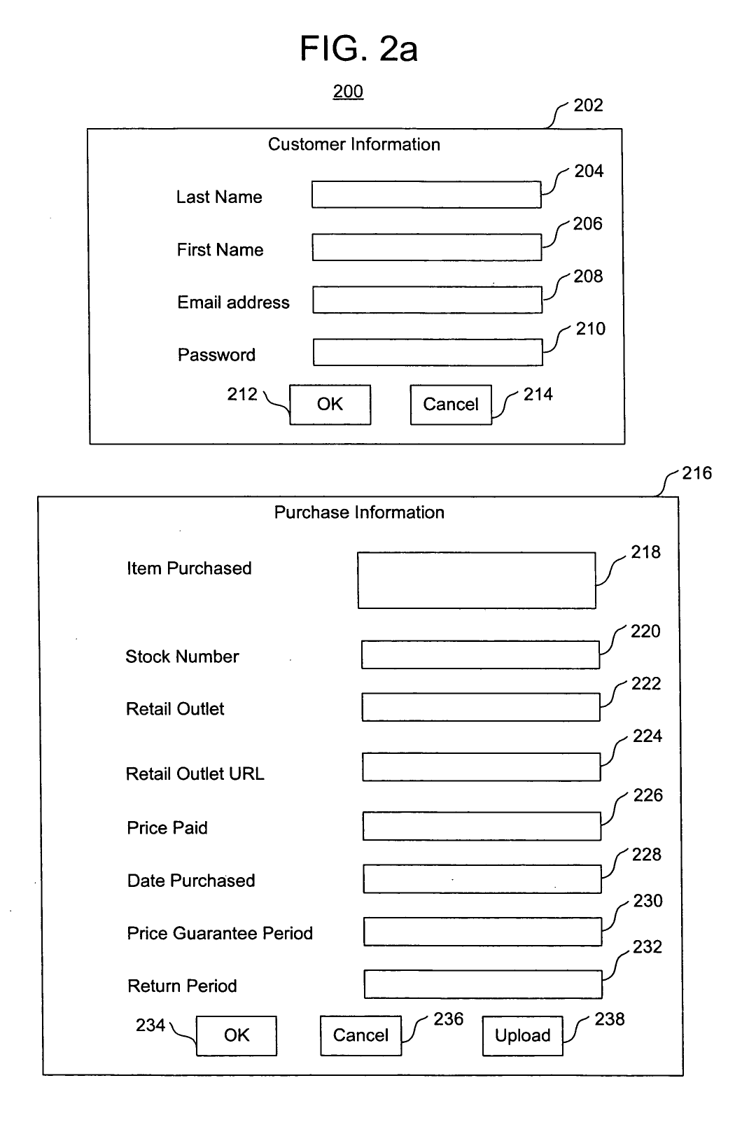

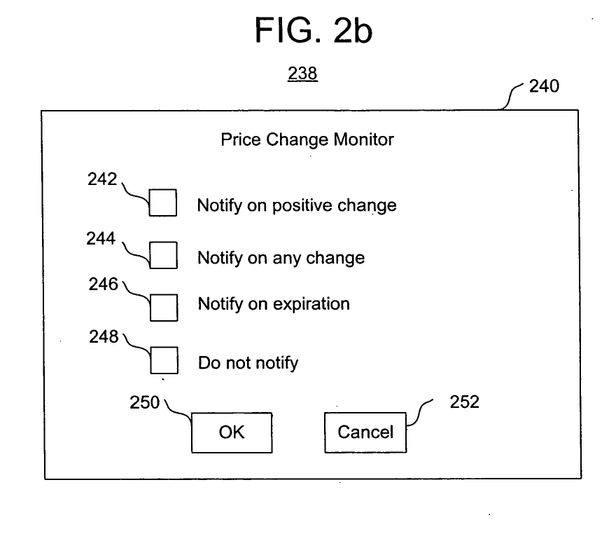

Referring now to FIG. 2a, information fields are illustrated in accordance with an example of the invention seen at 200. Consumer contact information is queried via a dialog box at 202. The consumer inputs his or her last name 204, first name 206, email address 208, and password 210. The consumer may optionally input their residential address, residential, cellular and/or business phone numbers and fax number(s).

If the consumer is satisfied with the dialog box entries, the consumer then selects the OK button 212 to enter their consumer information into the PPM Consumer Profile Record (CPR). The consumer may select the Cancel 214 button to clear the dialog box.

As seen in FIG. 2a, purchase information fields are depicted in accordance with an example of the invention at 216. A consumer's purchase information is queried via a dialog box at 216. The consumer inputs a description of the item purchased at 218. The description is, for example, the name of the purchased item, such as a Sony video recorder or Hewlett Packard laser printer. The consumer then enters the stock number 220 of the purchased item. The stock number may comprise the retail outlet stock number, the retail outlet internal part number, a Stock Keeping Unit (SKU) number, the manufacturer part number and/or combinations thereof.

In this example the consumer enters the name of the retail outlet 222 where the item was purchased, such as, for example BestBuy. Associated with the retail outlet may be a Universal Resource Locator (URL). The URL makes product and pricing information available to user of the World Wide Web (WWW). The consumer inputs the retail outlet URL at 224.

The consumer then, in this example, enters the price paid 226 for the purchased item. The price paid is typically in United States dollars, although in other examples the price paid may be in a foreign currency.

The next field the consumer enters in this example is the date purchased 228, which is the date the consumer purchased the item. Following the date purchased 228 field is the price guarantee period 230 field. The consumer enters, if know, the price guarantee period. The price guarantee period, in one example, is the interval of time when, if the price of the purchased item is lowered, the retail outlet where the item was purchased will refund the difference between the price paid and the current price of the item purchased, or will refund the price paid of the item purchased in its entirety. In another example, the price guarantee period is the interval of time when, if the price of the purchased item is lowered at any retail outlet or establishment, the retail outlet where the item was purchased will refund the difference between the price paid and the current price of the item purchased, or will refund the price paid of the item purchased in its entirety.

The consumer enters the return period of the purchased item in the return period 232 field. The return period for the purchased item may be, for example, thirty days. The return period may be identical to the price guarantee period, that is, the consumer may be entitled to a refund if the purchase price of the item becomes less than the price the consumer paid for the item within the return period.

When the consumer is satisfied with the data entered in the fields in the dialog box, the consumer may select the OK button 234. By selecting the OK button 234 the purchase information is entered into the consumer's CPR. If the consumer is not satisfied with the entered data, the consumer may select the Cancel 236 button to clear the dialog box data fields.

It is to be understood that the consumer may not need to enter data into every field within the purchase information dialog box. For example, a receipt for a purchased item may be scanned in and be recognized using Optical Character Recognition (OCR) software. Fields such as the stock number 220, retail outlet 222, retail outlet URL 224, price paid 226, date purchased 228 among others may be automatically recognized by the scanning software and placed in the appropriate dialog box fields. In this example, the consumer may upload the receipt for OCR scanning by placing the receipt in a scanning device and clicking the Upload button 238. The scanned receipt is typically saved as file. By clicking the Upload button 238, the file is transferred to the PPM for further processing.

In one example, the return and/or price guarantee policies may be printed on the back of the consumer's receipt. The OCR software may scan and parse the respective policies, extracting the return period and/or price guarantee periods. The consumer may scan and upload the receipt as in the manner described above.

In another example, a retailers return period and/or price guarantee periods may be known when scanning a receipt. In this example, the PPM will use the retailer name as an index into the purchased product database 412. In one example, the return period and/or price guarantee policy is updated. In another example, the return period and/or price guarantee policy is extracted from the purchased product database.

As seen in FIG. 2b, price change monitor fields are depicted in accordance with an example of the invention at 240. A consumer may set the reporting characteristics of the PPM by selecting one of four check boxes. The first check box, notify on positive change 242, configures the PPM to report to the consumer a difference between the purchase price paid for the item by the consumer and a new lower priced for the item offered by the retail outlet. This notification occurs if the favorable price differential occurs within the retailer's return period and/or price guarantee period.

It is to be understood that the retail outlet may offer a price guarantee not only for their own chain but for all other chains and/or outlets selling the identical purchased item. For example, Retailer One may offer a particular video recorder for a guaranteed low price, and if the video recorder is found at Retailer Two for a lower price, Retailer One will refund to the purchaser the difference and/or the entire amount.

The second check box, notify on any change 244, if set, configures the PPM to notify the consumer of any change in the price of the item purchased. The third check box, do not notify 248, if set, configures the PPM to notify the consumer on any price change in the purchased product at the retail outlet where the item was purchased and/or any other retail outlet.

The third check box, notify on expiration 246, configures the PPM to notify the consumer when the price guarantee period and/or the return period has expired. The fourth check box, do not notify 248, configures the PPM not no notify the consumer of any price change in the consumer's favor or not.

If the consumer is satisfied with the setting of the checkboxes, the consumer selects the OK button 250 to configure the PPM with respect to price change notification for a purchased item. In another example, any combination of check boxes may be checked, allowing the PPM to be configured in multiple ways.

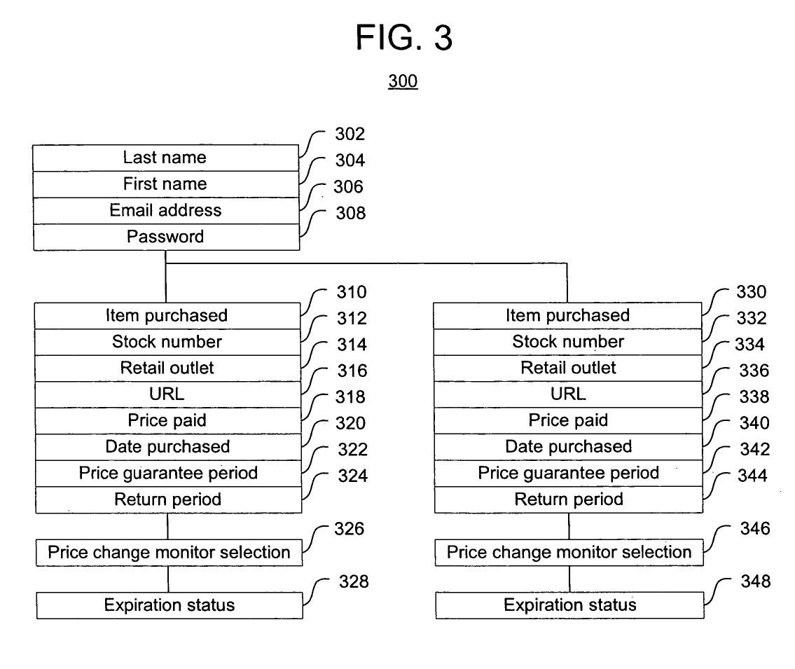

As seen in FIG. 3, an schematic diagram of a Consumer Profile Record (CPR) data structure is provided in accordance with an example of the invention at 300. A consumer's personal information is stored in fields 302, 304, 306, and 308. The consumer's personal information is comprised of a last name 302, a first name 306, an email address 306 and a password 308.

Associated with the consumer's personal information are a plurality of purchase information fields. The purchase information fields are comprised of a description of an item purchased 310, a stock number 312, the retail outlet where the item was purchased 314, the retail outlet's URL 316, the price paid for the purchased item 318, the date the item was purchased 320, the price guarantee period 322, the return period 324, the price change monitor selection 326, and the expiration status 328. The expiration status field 328 indicates, for example, whether the price guarantee period and/or the return period for the item purchased 310. It will be apparent to one skilled in the art that the personal information fields and associated purchase information fields may be implemented by a variety of data structures such as, for example, an object, a linked list, or any suitable data structure. In another example the fields may be implemented as an object, array of pointers, or any suitable data structure.

Additional purchase item fields may be associated with the consumer's personal information fields. Additional purchase item fields 330 through 348 contain purchase information for other items purchased. In this manner multiple purchases may be monitored. Additionally, purchase information records marked as expired may be persisted, advantageously allowing the consumer to maintain and view a history of purchases.

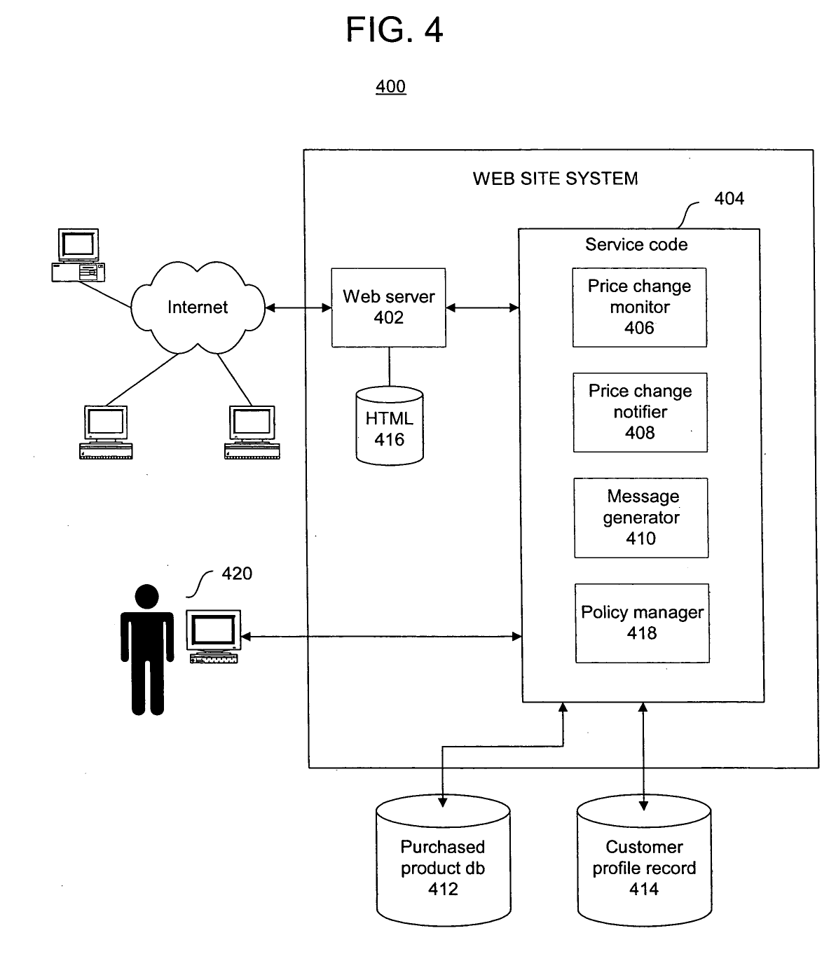

As seen in FIG. 4, a Web based system that may be used to implement the PPM is provided at 400. The Web based system includes a Web server 402 which accesses a database 416 of HTML and related content. The HTML database contains, among other things, the basic HTML documents used to generate consumer personal information, product information, and price change monitor pages of FIGS. 2a and 2b.

The Web server 402 accesses service code 404, which in turn accesses a purchased product database 412 and a consumer profile database 414. The databases are shown separately in FIG. 4 for purposes of illustration, but may in practice be combined within one or more larger database systems. The service code may be, for example, run on one or more Unix or Windows based servers and/or workstations.

The purchased product database 412 contains information relating to items purchased by a consumer, such as, for example, a plurality of purchase information fields providing identification of the one or more items purchased by the consumer. In one example, if two or more consumers purchase the same item, the respective consumer profiles will point to one instance of the purchase information fields providing identification of the item purchased by the two consumers. In this fashion duplication or purchased information fields may be obviated, advantageously saving storage space in the purchased product database 412.

The purchase product database 412 may also contain retrieved copies of a plurality of retailers return policies and/or price guarantee periods associated with a purchased product.

In another example, separate records may be maintained in a pool for various retailer return policies and/or price guarantee periods in the purchase product database 412. For example, when a consumer purchases a new item and registers with the PPM by filling in the consumer and purchase information fields, the retail outlet URL may be used as an index into the pool of retailer return policies and/or price guarantee periods. In this example, the pool of retailer return policies and/or price guarantee periods may be updated periodically by service code 404, independently of any search for a price change for an item purchased by a consumer.

Consumer profile record database 414 contains consumer profile records as previously described. The consumer profile record database is accessible by service code 404, which, in this example, contains a price change monitor 406, a price change notifier 408, a message generator 410, and a policy manager 418. The price monitor 406 contains the automaton that, via Web server 402, accesses retail outlet Web pages on the Internet. The price change monitor 406 accesses and updates the purchased product database 412 and the customer profile record database 414 by retrieving retailer Web pages and/or specific product information and pricing posted on retailer Web pages. If the automaton returns a price, or a Web page containing a price for a purchased item the price change monitor 406 will, in this example, access the purchased product database for the last known price of the purchased item. If a price change is determined, then the price change monitor 406 queries the customer profile record database 414 to determine if one or more consumers have registered the purchased item. If, for example, one or more consumers have indeed registered, and the price is different than the item purchase price, then the price change monitor 406 notifies the price change notifier 408, signaling that a message is to be sent to one or more consumers. In one example, data including but not limited to the consumer contact information and purchase information is passed by the price change monitor 406 to the price change notifier 408. The price change monitor 406, in one example, houses the OCR application. The price change notifier 408 executes communications to consumers. Communications may be, for example, an email, text message, and the like as previously described. In preparation for communicating with a consumer, the price change notifier 408, in one example, passes the result of the database queries to a message generator 410. The message generator 410 generates messages, for example, in different formats from stored forms, where the product name, new purchase price, consumer name, the return price guarantee expiration date are placed within one or more stored forms in preparation for the price change notifier 408 to send to one or more consumers. The message generator 410 signals the price change notifier 408 that one or more messages are prepared. The price change notifier 408 retrieves the prepared messages and sends to messages to consumers.

Policy Manager 418 contains the interface to the purchased product database 412, the Web service 402, HTML database 416, the Internet, and one or more purchase advisors 420. Price guarantee periods, policies, return periods and policies may be extracted from retailer Websites, receipts, and the like, or may be alternatively placed in the purchased product database by a purchase advisor 420 via the policy manager 418. In another example, retailers are allowed to update the purchase product database 412 via Policy Manager 418. Retailers may be, for example, allowed to update return and price guarantee information in the purchase product database 412 for one or more products by receiving a URL from the Policy Manager 418. By receiving the URL, retailers are able to update the purchase product database 412.

Advantageously, one or more purchase advisors 420 may enter caveats relating to the price guarantee period and/or return period. For example, rebates may not apply to a price guarantee offer. Items such as particular types of clothing, such as undergarments or swimwear, may not be returnable. For a given retail establishment, the purchase advisor 120 may enter this data into the purchased product database 412 via the policy manager 418. For example, when a price change detected by the price change monitor 406 for a purchased item appears to be advantageous to a consumer, due to the caveats described above, the consumer may not be able to take advantage of a favorable price differential and/or return the purchased product.

In another example, one or more purchase advisors 420 may perform the functions of the automation, that is, the purchase advisors 420 may periodically access retail outlet URLs and examine pricing for one or more items purchased by consumer. The purchase advisors 420 may update the purchased product database 412 with newly found pricing information.

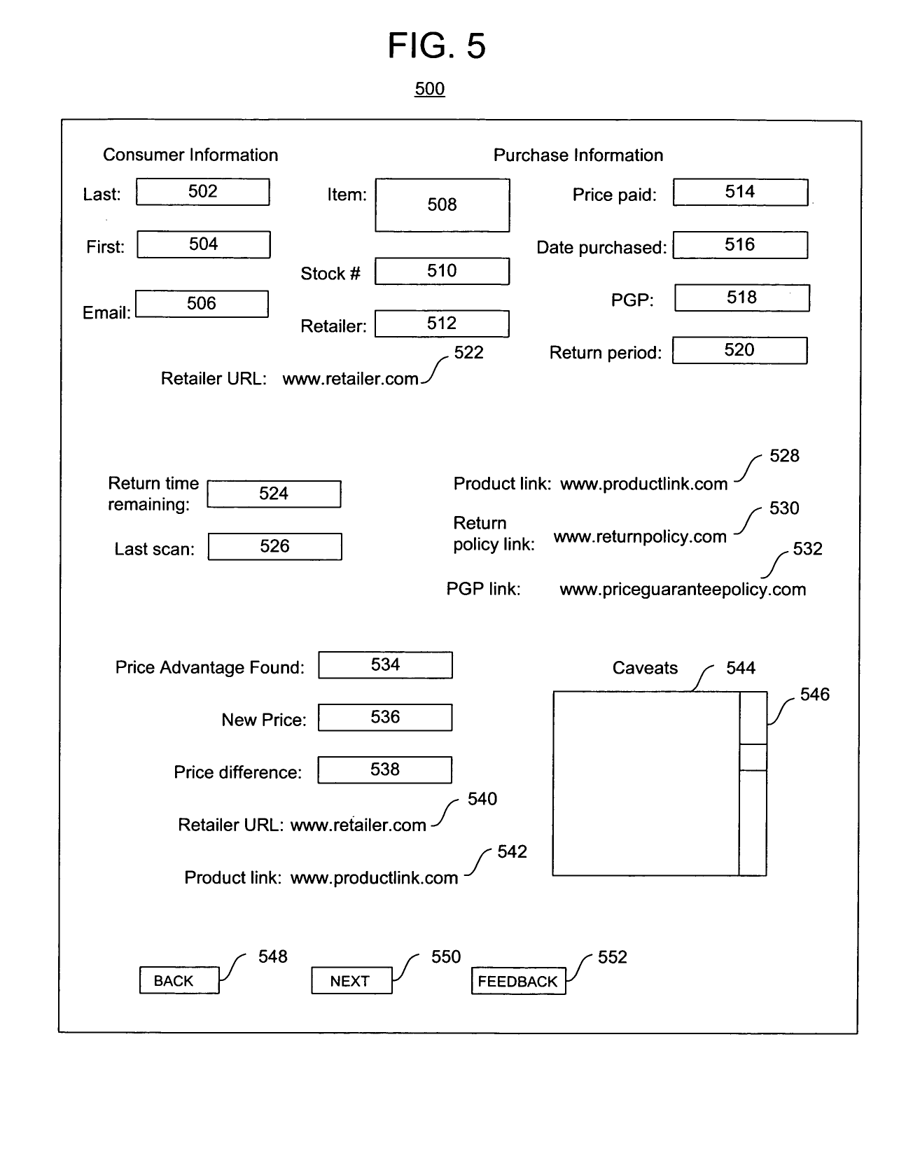

As seen in FIG. 5, a consumer and purchase information Web page is provided in accordance with an example of the invention at 500. Consumer information is displayed, with fields comprised off the consumer's last name 502, first name 504, and email address 506. Purchase information is displayed, with fields comprised of a description of the item purchased 508. It is to be understood that a text description may be displayed, a graphical representation of the item purchased may be display and/or combinations thereof.

The stock number is displayed at 510. The name of the retailer is displayed in 512. The retailer's URL is displayed at 522. The price paid for the item is displayed at 514. The date purchased is displayed at 516.

A price guarantee period (PGP) field is displayed at 518. In one example the PGP field contains the duration of the price guarantee period, which may coincide with the return period, and may be colored green. If no price guarantee period exists, then the field may be colored red.

The return period is displayed at 520. The return period may be, for example, thirty days. In another example, the return policy may be fourteen days.

The return time remaining is displayed at 524. The return time remaining field counts down from the date of purchase. In one example, the return period field 520 may count down with the return time remaining field 524. In another example the return period field 520 value may remain fixed.

The last scan 526 field displays when the price change monitor 406 last scanned for a price differential. The last scan 526 field may display, in one example, the date when the last scan occurred. In another example the last scan 526 field may display the date and time when the last scan occurred.

A URL link to the purchased item is provided at 528. The consumer may click on this link to view the product on the Web page of the retailer where the product was purchased, if the link still exists. A URL link to the retailer's return policy, if available via the Internet, is provided at 530. The consumer may click on this link to view the retail outlet's return policy. A URL link to the retailer's price guarantee policy (PGP), if it exists, is provided at 532. The consumer may click on this link to view the retailer's price guarantee policy.

If a difference in the price paid for the purchased item is discovered, the newly discovered price is displayed at 536. If the new price is lower than the consumer's purchase price of the item, then the price advantage found field 534, in one example, blinks green. The difference in price between the consumer's purchase price of the item and the newly discovered price is displayed at 538. The price displayed at 538 is not constrained by an advantageous price differential to the consumer. In one example, the price may be higher for the item purchased by the consumer. The URL where the new price was found is displayed at 540. This URL, in one example, may be the same URL where the consumer originally purchased the item. In another example, the URL may point to another retail chain outlet. The consumer may click the URL to view the retail chain's Web page. A URL to the product with the newly found price is displayed at 542. The consumer may click the URL to view the product at the newly found retail chain.

A Caveats text box is displayed at 544. Associated with the text box is a scroll bar 546 allowing the consumer to view the text presented in the box. The Caveats text box 544 presents text regarding any factors that may impede a favorable price difference between the item's original purchase price and the newly found price.

For example, the consumer may buy a laptop computer for a thousand dollar, and the PPM may find the same laptop computer for nine hundred dollars. A favorable price advantage for the consumer appears to be found. Upon further examination of the newly found nine hundred dollar price, the PPM finds that this is dependent upon a one hundred dollar rebate offer. Examining the return policy and/or price guarantee policy where the consumer originally purchased the item, the policy may state, for example, that rebates are excluded from a price guarantee policy. In this example the Caveats text box 544 will contain a statement “Rebates are excluded from the price match guarantee”, thus informing the user that even if a new, lower, and apparently favorable price is found for the item purchased, it may in fact may not be obtainable due to the rebate exclusion.

In another example, shipping charges may apply to a newly found price advantage. The Caveats text box 544 will contain the statement “Shipping charges apply.” In yet another example, the retailer where the consumer originally purchased the item may charge a re-stocking fee when an item is returned. In this example the Caveats text box will contain the statement “A restocking fee applies to returned items”. In one example the rebate exclusion, shipping charges, and/or restocking fee is factored into the price differential, sometimes revealing a disadvantageous price change from the consumer's perspective.

The consumer, over time, may have several purchases registered with the PPM. The consumer, in this example, is able to index through a history of purchases by clicking the back 548 or next 550 controls.

The consumer may provide feedback and/or comments regarding his or her experience with the PPM and/or with the retailer with respect to the ease or difficulty returning an item or with the retailer honoring its return and/or price guarantee policy by clicking on the feedback control 552. Clicking on the feedback control 552 invokes a new window containing radio buttons and text boxes. In one example, this feedback is made available to other consumers who have purchased similar items from a given retailer, allowing them to benefit from the experience of others.

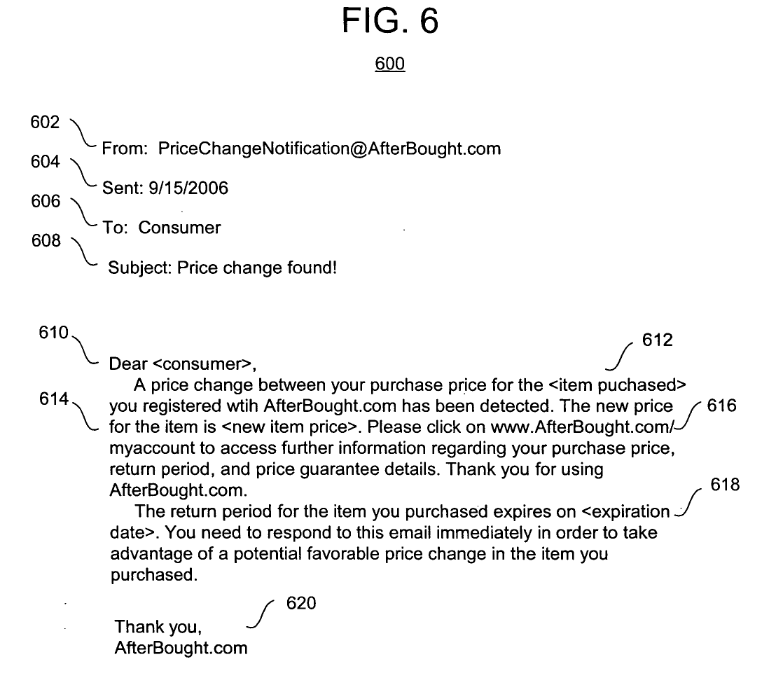

As seen in FIG. 6, a notification email is provided in accordance with an example of the invention at 600. From field at 602 indicates the source of the email. In this example, the source of the email is PriceChangeNotification@AferBought.com.

Sent field at 604 indicates the date the email notification was sent. To field at 606 indicates the recipient of the email notification. In this example the To field specifically addresses a particular consumer. The subject field at 608, indicating that a price change was found for an item purchased by the consumer. Consumer salutation at 610 specifically addresses the consumer. A text description and/or name of the specific item purchased is shown at 612. The consumer may click the URL at 616 to access further information regarding the purchase. When clicking the URL, the consumer will be directed to a set of pages as described in FIG. 5. At 618 the consumer is informed of the expiration date of the purchased item. A thank you to the consumer is shown at 620.

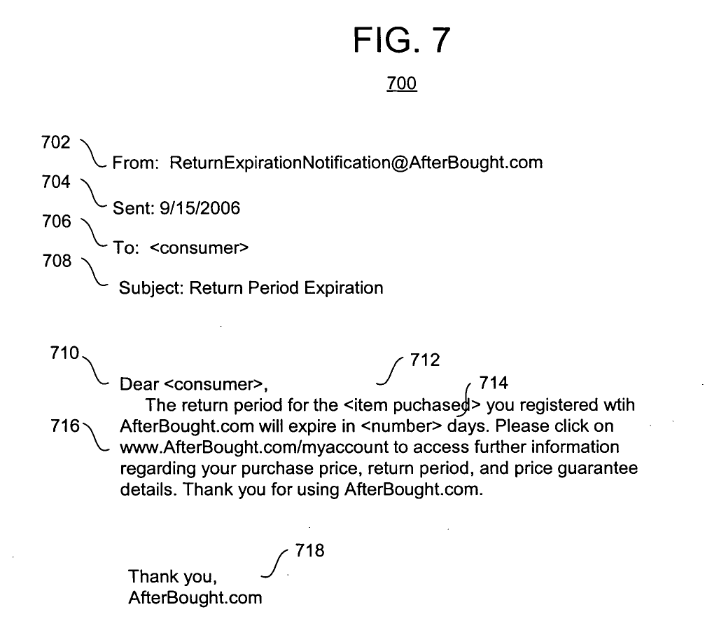

As seen in FIG. 7, another notification email is provided in accordance with an example of the invention at 700. The from field at 702 indicates the source of the email. The sent field at 704 indicates the date the email notification was sent. To field at 706 identifies the recipient of the email. The subject field at 708, in this example, indicates the impending return period expiration for an item purchased by the consumer.

The salutation field is at 710. The item purchased field at 712, providing a description and/or name of the item purchased. The number field 714 indicates the number of days remaining to return the item purchased. The number of days remaining are calculated from the date value in the sent 704 field. The consumer account field at 714 directs the consumer to one or more pages as described in FIG. 5. A thank you to the consumer is shown at 716.

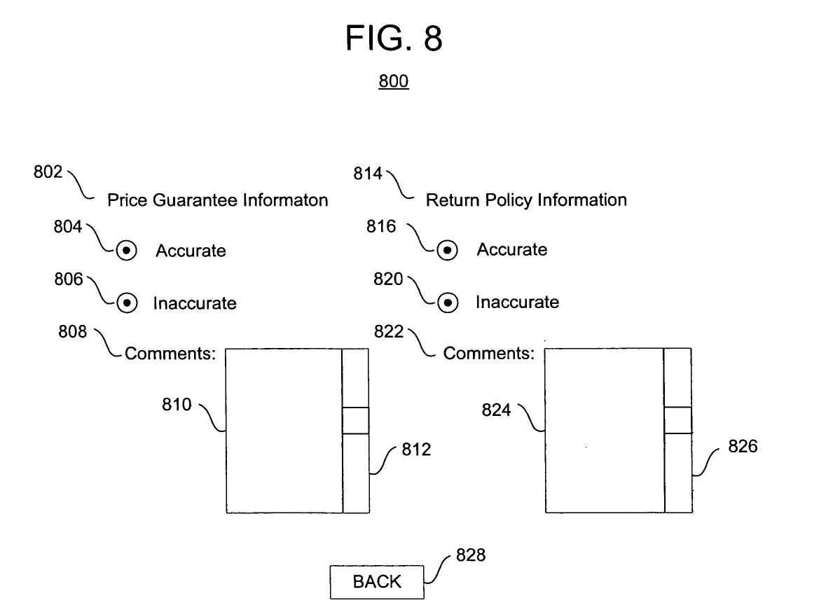

As seen in FIG. 8, user feedback fields are provided in accordance with an example of the invention at 800. Price guarantee information feedback controls are provided at 802. If the price guarantee information provided by the PPM is accurate, the consumer may click the Accurate radio control button 804. This informs the PPM that the price guarantee information provided to the user for the purchased item was accurate. If the price guarantee information is inaccurate, the consumer may click the Inaccurate radio control button 806. The user may enter what the user believed the inaccuracy or inaccuracies were in a text box 810. The user is able to scroll through the text box via the scroll bar 812. The information provided may be used to alter the information in the purchased product database 412. In one example, one or more operators may alter the data in the purchased product database 412 via the policy manager 418. The information provided by the consumer may be combined with the information provided via the caveats text box 544 and placed in the purchased product database 412.

Return policy information feedback is provided at 814. If the return policy information provided the PPM is accurate for the purchased item, then the user may click on the Accurate radio control 816. This informs the PPM that the return policy information provided to the user for the purchased item was accurate. If the return policy information is inaccurate, the consumer may click the Inaccurate radio control button 820.

The consumer may enter what the user believed the inaccuracy or inaccuracies were in text box 824. The consumer is able to scroll through the text box via the scroll bar 826. The information provided may be used to alter the information in the purchased product database 412. In one example, one or more purchase advisors 420 may alter the data in the purchased product database 412 via the policy manager 418. The information provided by the consumer may be combined with the information provided via the caveats text box 544 and placed in the purchased product database 412.

The consumer may return to the consumer and purchase information Web page 500 by clicking the back control 828.

It is to be understood that the foregoing description is not a definition of the invention itself, but is a description of one or more preferred exemplary embodiments of the invention. The invention is limited to the claims below. Furthermore, the statements contained in the foregoing description relate to particular embodiments and are not to be construed as the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example”, and “such as”, and the verbs “comprising”, “having”, “including”, and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1-17. (canceled)

18. A computer assisted method for post purchase price monitoring for an item purchased by a consumer comprising the steps of:
receiving purchase information for one or more items purchased by the consumer at one or more retail outlets;
searching a plurality of retail outlets for a price guarantee policy, price guarantee period, and return period for the items purchased responsive to the step of receiving wherein the step of searching is performed by an automaton;
monitoring for a price change at a plurality of retail outlets for the items purchased responsive to the step of searching wherein the step of monitoring is performed by an automaton; and
notifying the consumer of a price change for the items purchased responsive to the step of monitoring wherein the step of notifying further comprises the step of informing the consumer of an impending expiration of the return period for the item purchased via said automaton.

19. The method of claim 18 wherein said automaton is utilized by a first timer including a lower bound and upper bound.

20. The method of claim 19 wherein said first timer lower bound is comprised of the date of the item purchased.

21. The method of claim 19 wherein said first timer upper bound is comprised of the expiration of the return period.

22. The method of claim 18 wherein said automaton is utilized by a second timer periodically search said plurality of retail outlets.

23. The method of claim 22 wherein said second timer search period is weekly.

24. The method of claim 22 wherein said second timer search period is daily.

25. The method of claim 22 wherein said second timer search is asymmetrical, wherein the search period increases in frequency.

26. The method of claim 19 wherein first timer includes an expiration threshold value.

27. The method of claim 26 wherein said first timer expiration threshold is weekly.

28. The method of claim 26 wherein said first timer expiration threshold is daily.

29. The method of claim 26 wherein said first timer expiration threshold increases in frequency as the timer value approaches said expiration of said return period for said items purchased.

30. A computer assisted system for post purchase price monitoring for an item purchased by a consumer comprising the steps of:
means for receiving purchase information for one or more items purchased by the consumer at one or more retail outlets;
means for searching a plurality of retail outlets for a price guarantee policy, price guarantee period, and return period for the items purchased responsive to the step of receiving wherein the step of searching is performed by an automaton;
means for monitoring for a price change at a plurality of retail outlets for the items purchased responsive to the step of searching wherein the step of monitoring is performed by an automaton; and
means for notifying the consumer of a price change for the items purchased responsive to the step of monitoring wherein the step of notifying further comprises the step of informing the consumer of an impending expiration of the return period for the item purchased via said automaton.
